(19) United States
(12) Patent Application Publication
(10) Pub. No.: US 2021/0271268 A1
(43) Pub. Date: Sep. 2, 2021

(54) BEACON DISCOVERY SYSTEM

(71) Applicants: Landon Wagner, Dillon, CO (US); Jaya Lange, Leadville, CO (US); Todd Brower, Dillon, CO (US)

(72) Inventors: Landon Wagner, Dillon, CO (US); Jaya Lange, Leadville, CO (US); Todd Brower, Dillon, CO (US)

(21) Appl. No.: 17/249,342

(22) Filed: Feb. 26, 2021

Related U.S. Application Data
(60) Provisional application No. 62/982,451, filed on Feb. 27, 2020.

(51) Int. Cl. G05D 1/10; G05B 19/042

(52) U.S. Cl. CPC G05D 1/101; G05B 2219/25252; G05B 19/042

(57) ABSTRACT

A beacon discovery system can utilize one or more automated devices to wirelessly identify a location of one or more beacons positioned in an out-of-site location. Intelligent execution of a detection strategy by a detection module of the beacon discovery system can provide fast and efficient recovery of a beacon by adaptively utilizing multiple different automation and wireless positioning technologies.

### RELATED APPLICATION

The present application makes a claim of domestic priority to U.S. Provisional Patent Application No. 62/982,451 filed Feb. 27, 2020, the contents of which are hereby incorporated by reference.

### SUMMARY

In accordance with some embodiments, a beacon discovery system has a beacon with a first communication circuit and a first automated device with a detection module and a second communication circuit configured to pass signals to the first communication circuit. The automated device configured to discover the beacon by executing a detection strategy generated by the detection module.

Other embodiments of a beacon discovery system involves launching an automated device that consists of a detection module and a first communication circuit prior to generating a detection strategy with the detection module in response to at least one detected condition. The detection strategy is then executed with the automated device to discover a beacon that consists of a second communication circuit.

### BRIEF DESCRIPTION OF THE DRAWINGS

FIG. 1 provides a functional block representation of an example beacon environment in which assorted embodiments may be practiced.

FIG. 2 depicts a block representation of an example beacon that can be employed in a beacon discovery system in accordance with some embodiments.

FIG. 3 depicts a block representation of an example receiver capable of being utilized in a beacon discovery system in accordance with various embodiments.

FIG. 4 depicts a functional block representation of an example beacon discovery system configured in accordance in some embodiments.

FIG. 5 depicts a block representation of an example detection module of a beacon discovery system arranged in accordance with assorted embodiments.

FIG. 6 depicts a functional block representation of portions of an example beacon discovery system operated in accordance with some embodiments.

FIG. 7 depicts a functional block representation of a beacon discovery routine carried out in accordance with various embodiments.

FIG. 8 depicts portions of a beacon discovery system operated in accordance with assorted embodiments.

FIG. 9 is an example beacon discovery routine that can be carried out with the respective embodiments of FIGS. 1-8.

### DETAILED DESCRIPTION

Without limitation, various embodiments of a beacon discovery system, disclosed herein, are generally directed to hardware and software configured to intelligently provide optimized recovery of at least one beacon positioned in an out-of-sight location, such as underground or beneath an avalanche.

Safety beacons have been utilized in a variety of iterations to identify the location of someone or something. While early safety beacons were little more than flags, flares, or candles, the advent of computing technology has allowed beacons to contain sound, light, and safety components that can aid in beacon discovery and/or survivability of a user. Despite the computing sophistication of a beacon, difficulties remain for locating a beacon, particularly in treacherous terrain, such as mountains, mines, and debris. That is, audio, visual, and computerized tracking capabilities for a beacon may not provide optimal beacon discovery and recovery due to the beacon being out of a line-of-sight and/or otherwise hidden from visual or audio range.

Accordingly, assorted embodiments are directed to an intelligent beacon system that can utilize one or more autonomous devices to speed the discovery and recovery of a beacon regardless of the environment in which the beacon is positioned. The ability to utilize computing capabilities of a beacon, receiver, and autonomous device to generate and execute a detection strategy provides adaptive behavior that can decrease the time between beacon activation and recovery. The execution of a detection strategy can involve one or more recovery actions that further aid in the recovery of a discovered beacon, which corresponds with heightened safety and survivability for a user of the beacon.

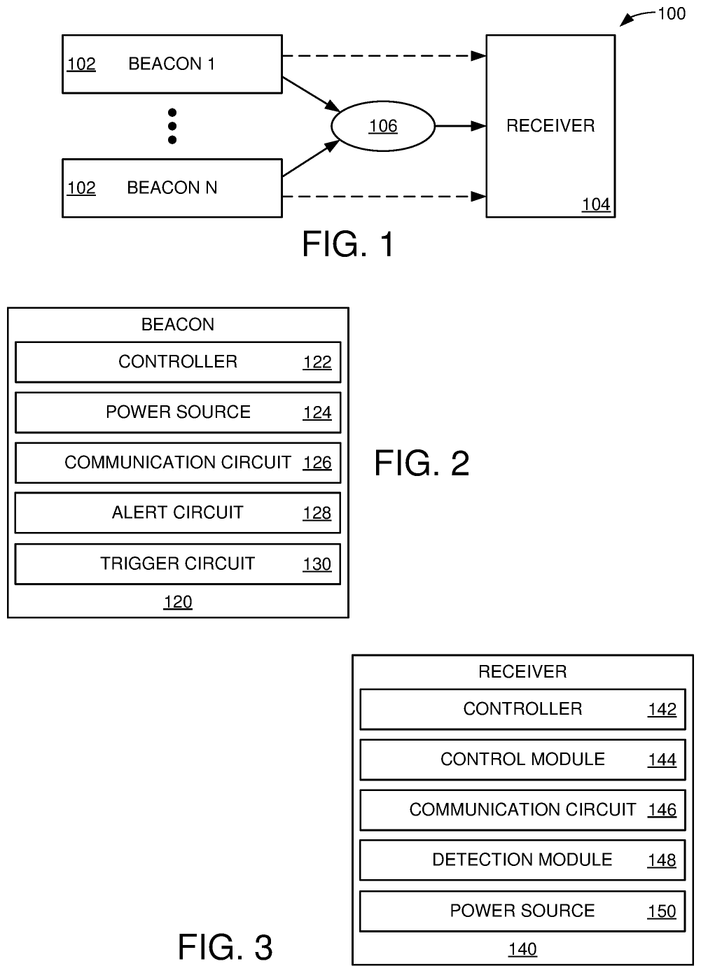

Turning to the drawings, FIG. 1 illustrates a block representation of an example beacon environment 100 in which assorted embodiments can be practiced. Any number (N) of separate beacons 102 can be discovered by one or more receivers 104 via a network 106 consisting of wired signal pathways, as shown by solid lines, and/or wireless signal pathways, as shown by segmented lines. A beacon 102 may consist of hardware and software that promotes discovery once triggered by manual and/or automated activation. A receiver 104 can consist of hardware and software configured to discover the respective beacons 102 through one or more discovery actions.

The ability to communicate data and commands between beacons 102 and a receiver 104 via one or more signal pathway allows for efficient beacon 102 discovery. However, the use of a single receiver 104 that is controlled, or tethered to, a user may be inefficient due to the user's capability to move over terrain and process information to locate and recover a beacon 102. Hence, difficulties and inefficiencies are present in beacon 102 discovery systems that involve the manual operation and movement of a receiver 104.

FIG. 2 depicts a block representation of an example beacon 120 that can be employed in the beacon environment 100 of FIG. 1 in accordance with some embodiments. A beacon 120 can utilize one or more controllers 122, such as a microprocessor or other programmable circuitry, that directs operation of various hardware and software aspects associated with identifying a location when activated from one or more mobile power sources 124.

The controller 122 can function to choreograph operation of communication 126, alert 128, and trigger 130 circuitry that respectively are configured to provide different practical and electrical operations. The communication circuit 126 can provide the ability to ping, poll, establish one or more data pathways, and communicate with at least one receiver 104. It is contemplated that the communication circuit 126 can conduct one or more communications operations, such as transmitting data and polling for additional receivers 126, concurrently or sequentially. The communication circuit 126 may establish and/or utilize one or more signal pathway protocol, such as cellular, radio, secure wireless, or unsecure wireless, concurrently or individually to communicate with one or more receivers 104.

A beacon controller 122 may further direct operation of an alert circuit 128 that controls one or more identifying mechanisms directed to aid in the location of the beacon 120. While not required or limiting, the alert circuit 128 may carry out acoustic, visual, mechanical, and thermal mechanisms to aid the receiver, and user, in discovering the location of the beacon 120 as well as the beacon 120 itself. The alert circuit 128 can operate in concert with a trigger circuit 130 that determines when the beacon 120 is being located, or pinged, by the receiver/user. The trigger circuit 130 can operate manually with activation via a user's touch, gesture, or verbal command. However, other embodiments of a trigger circuit 130 activate one or alert mechanisms in response to detected conditions, such as a sensed fall, change in environmental conditions, or user situation.

The assorted aspects of the beacon 120 allow for automated, and manual, operation that aids a receiver in locating and discovering the beacon 120, which may be obscured or hidden even when a location is identified. While the beacon 120 can provide sophistication that increases the efficiency of discovery once activated, a receiver 104 can play an important role in reducing the time from beacon 120 activation to discovery. FIG. 3 depicts a block representation of an example receiver 140 that can be used with the beacon 120 as part of an intelligent beacon discovery system operated in accordance with some embodiments. The receiver 140 can utilize one or more controllers 142 that are programmed with intelligence to carry out and adapt the discovery of one or more beacons 120/102.

A receiver controller 142 can direct a control module 144 that is configured with circuitry that allows for autonomous and/or manual operation of the receiver 140 itself as well as one or more autonomous devices. The control module 144 can allow for a user to direct operation of a remote device, such as a vehicle, camera, or unmanned aerial drone. Such control may be involve position management as well as capability management, such as sensor, environmental detection, and physical manipulation of the environment. Some, or all, of the manual capabilities of a controlled device can be automated by the receiver so that a user does not have to input any information or feedback for the device to conduct one or more activities intended to discover a beacon.

The ability of the control module 144 to provide manual and/or automated activity for one or more devices can be enabled by a communication circuit 146 that can establish, utilize, and discard one or more signal pathways individually, concurrently, or sequentially. The assorted signal pathways provided by the communication circuit 146 can be utilized by a detection module 148 to carry out intelligent discovery of a beacon. The detection module 148 can input a variety of information from the receiver 140 and from remote devices to adaptively execute beacon discovery. That is, the detection module 148 allows for an otherwise static beacon discovery process to be adapted to current detected conditions that increase the efficiently and speed of beacon location identification.

The various aspects of a receiver 140 can be electrically supplied by a local power source 150. It is contemplated that the local power source 150 is rechargeable and/or replaceable to provide electrical recharging of at least one discovery device. Such local powering of discovery devices allows for efficient device deployment without concern for device electrical charge, which can provide increased efficiency and practicality, particularly in rural and/or remote locations where electrical power is scarce.

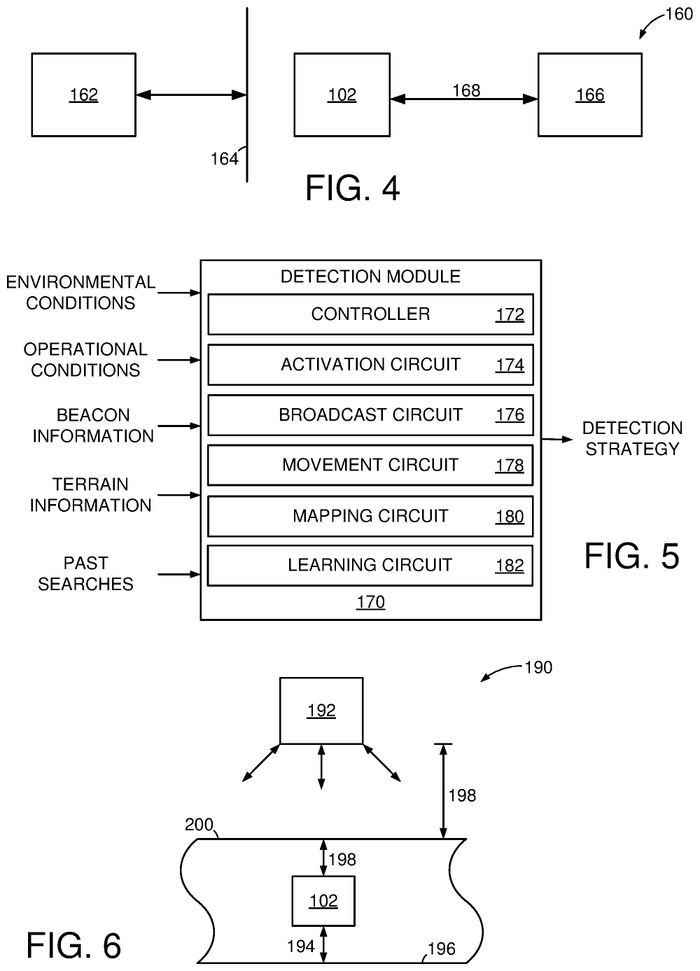

FIG. 4 depicts portions of an example beacon discovery system 160 operated in accordance with some embodiments. Despite the use of relatively sophisticated computing components for a receiver and beacon, issues remain in the efficient discovery of an activated beacon. Some issues can involve the capabilities of the beacon and/or receiver, such as line of sight, as illustrated by receiver 162 being blocked from the beacon 102/120 by a physical obstacle 164, or range, as illustrated by receiver 166 being separated from the beacon 102/120 by too great a distance 168.

While these, and other, issues of identifying the location, and subsequently discovering, a beacon may be resolved with added time searching with a receiver 162/166, but such additional time can have critical ramifications in beacon discovery operations in response to natural disasters, such as cave-ins, avalanches, or fire recovery. It is contemplated that the exclusive use of manual control of receiver or automated activation of a beacon searching device can similarly suffer from extended search and recovery times. For instance, manual movement in response to pinging a beacon for a signal or waiting for a static automated search to identify a beacon location can be unduly long and imprecise. With these issues in mind, assorted embodiments utilize at least a detection module to optimize the searching, identification, and discovery of at least one beacon.

FIG. 5 depicts a block representation of an example detection module 170 that can be employed in a beacon discovery system in accordance with various embodiments. The detection module 170 may employ one or more local controllers 172, which may be a processor or programmable circuitry of a receiver, automated search device, and/or beacon. The local controller 172 can correlate a variety of different inputs from one or more different sensors to generate a detection strategy based on current detected conditions. For instance, but in no way limiting, the detection module 170 can input information about past, current, and predicted environmental conditions, operational conditions associated with a beacon search, beacon status, terrain information, and receiver status.

The inputted information allows an activation circuit 174 of the detection module 170 to determine how and when to activate one or more automated search devices, such as a wireless ground vehicle or aerial drone. That is, the activation circuit 174 can contribute at least one triggering threshold to the detection strategy to prompt activation of a search device. For example, the activation circuit 174 can input environmental conditions, terrain information, and beacon information to generate a ground vehicle threshold of a ground pitch and surface roughness along with an aerial drone threshold of a certain visibility and wind speed. With the established triggering threshold(s), the detection strategy can activate one or more ground and aerial search devices automatically in response to detected conditions to efficiently search for an active beacon.

The computing sophistication of a beacon can allow for more than one wireless tracking, locating, and/or identifying signals, such as radio, sonar, light, and other frequencies capable of supporting signal transmission. The ability to communicate and/or locate different signals from, or to, a beacon allows the detection strategy to provide various search device broadcast adaptations based on detected searching conditions. The broadcast circuit 176 of the detection module 170 can generate one or more broadcast adaptations, such as length of broadcast, number of concurrent signals being broadcast or received, and directionality of signals being broadcast or received, that automatically adjust to detected environmental and operational conditions to efficiently locate a beacon.

As a non-limiting example, the detection strategy may involve using a broad spectrum of different signals to quickly sweep an area and subsequently employ a signal with high resolution, such as radio, sonar, or wi-fi frequencies, to pinpoint the location of the beacon. The automatic adaptation of broadcast signals to sensed search conditions allows for a search device, such as a ground vehicle, aerial drone, or manually operated receiver, to utilize more technology to find a beacon faster. Such automatic adaptation to sensed search conditions can also be used to optimize the movement of a search device, as directed by a movement circuit 178. That is, the movement circuit 178 can prescribe a variety of movement adaptations for one or more search devices in the detection strategy to provide the fastest possible location of a beacon.

It is contemplated that the movement circuit 178 prescribes different movement patterns for concurrently deployed search devices. In some embodiments, the detection strategy involves several different movements for at least one search device that are triggered by detected thresholds, such as overall search time, strength of beacon signal received, amount of ground area to cover, previous search movement resolution, search device power status, or terrain conditions. Movement adaptations are not limited to ground plane directions and can additionally, or alternatively, consist of elevational adjustments, such as flying an aerial drone lower in response to detected terrain, greater beacon signal strength, or an elapsed search time. The elevational adjustments can also adapt in response to the deployment of other search devices, as prescribed by the detection strategy, to provide faster beacon discovery.

While not required or limiting, a search device can be used to map terrain to provide information that can be used to more quickly locate a beacon. A mapping circuit 180 of the detection module 170 can take inputted terrain information from existing models and search device sensing to generate a current terrain map that can be used reactively and proactively by the detection strategy to prompt movement and/or broadcast adaptations that are optimized for the current terrain. Such mapping capabilities allows the detection module 170 to deploy a search device with little information about the terrain being searched and proceed to find optimal searching parameters for one or more devices automatically with the detection strategy.

The detection module 170, in some embodiments, employs a learning circuit 182 to log searching activity from one or more search devices and generate at least one unique searching algorithm that allows the detection strategy to more efficiently search for beacons in the future. That is, the learning circuit 182 can generate one or more algorithms that predict future searching activity in response to detected searching conditions, which improves the detection strategy to provide optimized efficiency and speed of beacon discovery. For instance, the learning circuit 182 can develop an algorithm for search device movement adaptations that can be employed as part of the detection strategy to increase the efficiency and speed of search device adaptations in response to detected search conditions due to the algorithm accurately predicting future searching conditions, such as strength of beacon signal, location of beacon signal, or efficiency of search vehicle elevation.

FIG. 6 depicts a line representation of portions of an example beacon discovery system 190 operated with a detection module 170 in accordance with various embodiments. As shown, an aerial search device 192 is flying in search of a beacon 102/120 that is buried, out-of-sight. While not required, the example beacon is positioned a first distance 194 from a ground level 196 and a second distance 198 from a cover level 200, which may be formed of continuous or sporadic debris or material, such as snow in the case of an avalanche, dirt in the case of a cave-in, or water in the case of a submerged beacon rescue.

As directed by the detection strategy, the altitude 202 of the search device 192 can be automatically adapted to provide fast, accurate detection of beacon signals 204 as well as terrain information 206 and environmental conditions 208. In response to the detected environmental, operational, and/or terrain information, the search device 192 can adapt its position, type of signal detection, type of broadcast signal, sensed environmental condition, and sensed terrain information to quickly identify the location of the beacon 102/120. It is contemplated that the search device 192 can conduct one or more movement and/or operational adaptations to determine the depth of the beacon 102/120 relative to the cover level 200. That is, the detection strategy may direct the search device 192 to generally find the location of the beacon 102/120 with a first set of searching parameters, such as altitude 202, movement speed, movement pattern, and beacon searching signal type, before conducting a second set of searching parameters that are directed at determining the depth of the beacon 102/120 under the cover level 200.

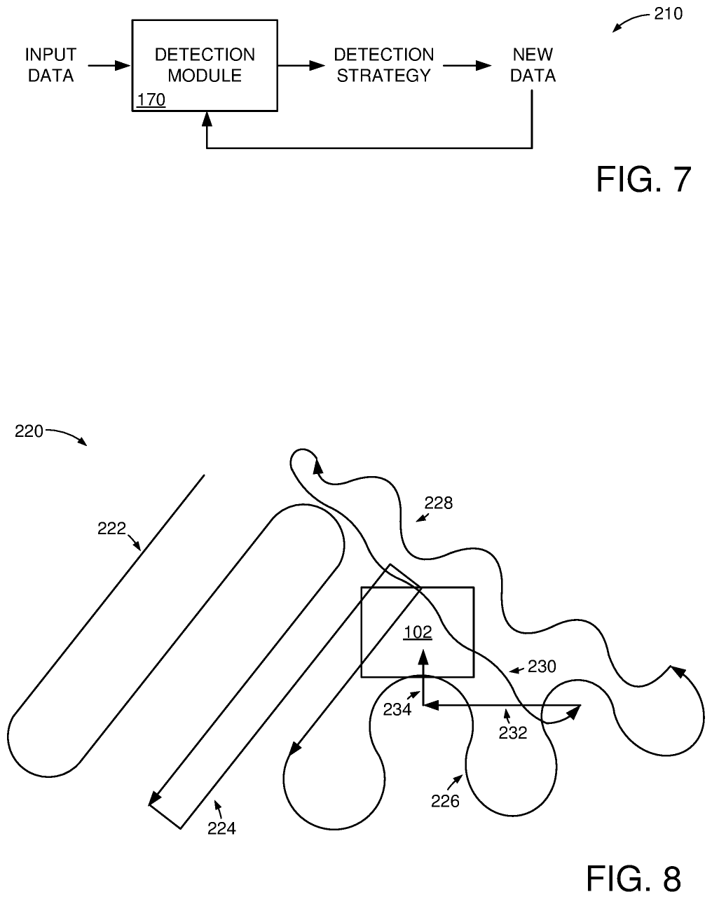

While a detection strategy may provide a number of different adaptations to searching parameters based on a variety of encountered searching conditions, a detection strategy is not required to be static. FIG. 7 depicts a functional block representation of an example beacon discovery process 210 conducted in accordance with assorted embodiments. As generally conveyed in FIG. 5, various input data, information, and conditions can be processed by a detection module 170 to create a detection strategy that prescribes a variety of different search device adaptations in response to sensed searching conditions in an effort to quickly and accurately locate a beacon.

However, a search device, beacon, and/or manually operated receiver can provide new data, information, or conditions that prompt the detection module 170 to modify, or replace, the existing detection strategy. Although the detection module may alter or replace an existing detection strategy for any reason, it is contemplated that a determination that the existing strategy is not optimal prompts the detection module to reconstruct portions of the strategy. It is also contemplated that detection of unconsidered environmental, operational, or terrain conditions triggers the process 210 to generate portions of a new detection strategy.

In FIG. 8, a top view line representation of an example beacon discovery system 220 is displayed in a non-limiting operational embodiment. In response to a generated detection strategy, a search device, such as a ground vehicle or aerial drone, can move in a specific pattern, as shown by solid arrows. In the non-limiting example of the system 220, a device begins with a first movement pattern 222, as prescribed by a detection strategy, in which an area is covered while pinging, polling, or otherwise exploring for a beacon 102/120. It is contemplated that the initial movement pattern 222 has a first resolution, as defined by the amount of ground area covered per unit of time, while a second movement pattern 224 is triggered to provide a different resolution.

Although any movement pattern can be conducted for any amount of time, some embodiments of a detection strategy involves executing different movement patterns with different resolutions in response to detected beacon signal(s) and/or overall search time. That is, a movement pattern may be conducted for a prescribed amount of time regardless of how strong a beacon signal is received or can be adapted to a different movement pattern based on the amount of time already spent searching and the strength of beacon signal received. The actual movement of a search device can be continuously linear, such as pattern 224, or continuously curvilinear, such as patterns 226, 228, and 230. The ability to adapt curvilinear movement patterns to have different diameters and/or arched trajectories allows a detection strategy to efficiently cover a variety of angles over an area of terrain to pinpoint the location of a beacon 102/120.

Various embodiments can execute one or more movement patterns to determine the depth of a beacon 102/120 below a cover/ground level. For instance, one or more movement patterns can be conducted to generally discover the location of the beacon 102/120 while additional movement patterns are conducted to identify where the beacon 102/120 is located relative to the topmost surface, which can be characterized as bury depth. The use of different movement patterns can correspond with different elevations, in the event the search device is a flying drone. As a non-limiting example, vector movement patterns 232 and 234 can each correspond with varying, or progressively lower uniform, elevations above ground, which can provide greater information to a detection module to identify the location and bury depth of an out-of-sight beacon 102/120.

With the use of different movement patterns by a search device, the location of a beacon 102/120 can be quickly ascertained. The ability of the search device to conduct a variety of movements efficiently, such as turns, linear motion, and vectors, allows for a more precise beacon location to be determined from multiple different sides of the beacon 102/120 than if a simple, one-sided, beacon signal tracking is used to locate the beacon 102/120. In other words, the movement patterns with different resolutions that track beacon signals from a 360 degree periphery of a beacon 102/120 can pinpoint a beacon's location quicker and with greater accuracy than if a beacon's signal is simply tracked from one-side of the beacon 102/120 with signal strength. The ability to adapt search device broadcast profiles can further complement the diverse movement patterns to provide precise beacon location discovery quicker than any known method.

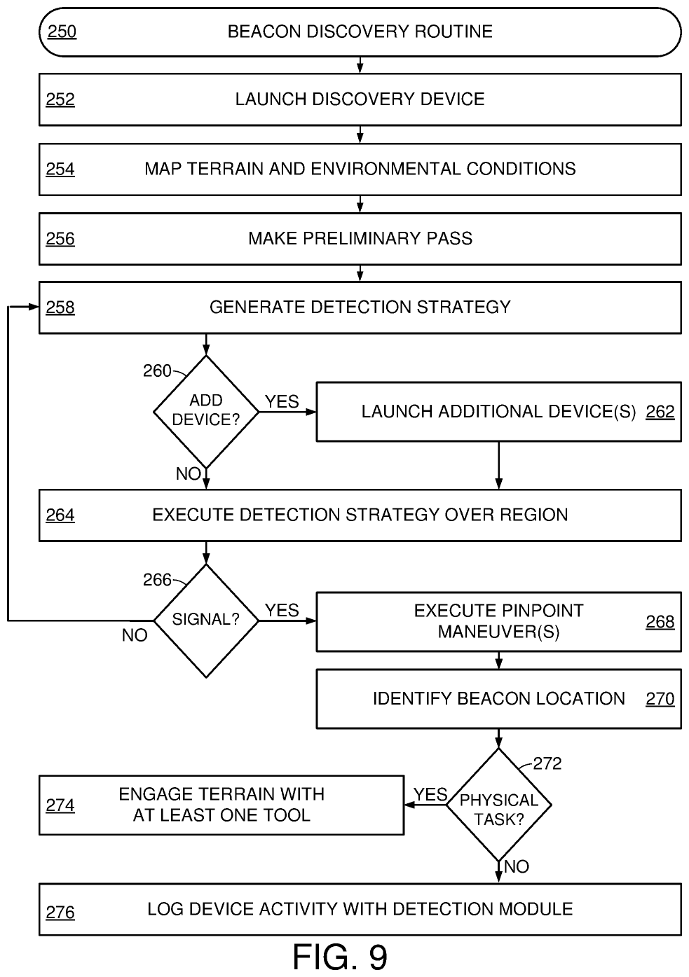

FIG. 9 depicts an example beacon discovery routine 250 that can be carried out with the assorted embodiments of FIGS. 1-8 to quickly and accurately discover at least one beacon. It is initially noted that routine 250 is conducted without a default or starting detection strategy in place, but some embodiments of a discovery routine begin by generating a detection strategy prior to taking steps to search an area for a beacon. In routine 250, at least one search device is launched in step 252 in response to an indication that a beacon is active and requesting discovery.

A launched device, along with one or more automated or manually operated receivers, can begin to map the terrain to be searched and detect the environmental conditions in which the search will occur in step 254. While step 254 may be conducted continuously or sporadically at any time during routine 250, the initial detection of terrain and environmental conditions allows an initial device pass over an area to be more intelligently routed compared to blindly sending a search device out without identifying terrain and environmental metrics, such as pitch, roughness, wind, temperature, and visibility. Hence, step 256 proceeds to make a preliminary pass over some, or all, of a search area, which may involve additional terrain mapping and/or environmental detection with on-board sensors as well as pinging, polling, and otherwise exploring for beacon signals, such as acoustic, visual, wireless data, and wireless communication signals.

It is contemplated that the preliminary pass of step 256 can locate a beacon. However, the preliminary pass of step 256 may provide an imprecise beacon location that corresponds with an area too great for efficient beacon recovery based on the terrain and/or environmental conditions. For instance, a beacon activated after an avalanche may be generally located by a preliminary pass, but such a general location can jeopardize the safety of recovery personnel based on the temperature, mountain terrain, and presence of snow. Thus, some embodiments proceed to generate a detection strategy in step 258 in response to inputted data from the search device before and during the preliminary pass.

The detection strategy resulting from step 258 can prescribe a variety of different movement, elevation, and broadcast adaptations to various triggering thresholds, such as detection of environmental or operational metrics. The detection strategy may prescribe the launching of additional search devices that operate in a complementary capacity. Decision 260 determines if search conditions are ripe, according to the detection strategy, for an additional device to be launched. If so, step 262 then launches the number and type of additional search devices to participate in the execution of the detection strategy for a designated search region in step 264.

Alternatively, if no additional search devices are called for in decision 260, the existing search device is used to execute the detection strategy of step 258. At some time during the execution of the detection strategy, a beacon signal can be acquired. Decision 266 evaluates if a reliable beacon signal is received. If no reliable signal has been found after an amount of time or prescribed search conditions are present, the detection strategy is reevaluated by returning routine 250 to step 258. In the event a reliable signal is received either by a receiver or a search device, step 268 then executes different movement patterns and/or maneuvers, in accordance with the actions prescribed by the detection strategy, to pinpoint the location of the reliable beacon signal in step 270. It is contemplated that the pinpointing movements/maneuvers can involve varying device elevation and/or activation of additional detection equipment, such as additional sensors, broadcast capabilities, or mechanical mechanisms.

The identification of a reliable beacon location in step 270 may prompt a search device to activate one or more location alerts, such as lights, sounds, flags, or digital tracking tags. With a flying drone search device, identification of a beacon's location in step 270 can prompt the drone to land atop the beacon's location. A ground search device may similarly stop atop a beacon's location to aid in recovery personnel finding the identified location. Regardless of the type of search device present atop an out-of-sight beacon, decision 272 evaluates if the search device(s) are to engage in one or more physical tasks prescribed by the detection strategy to speed the recovery of the beacon.

A choice for physical engagement prompts step 274 to contact the terrain proximal to the beacon with at least one tool. Such engagement may aid in locating the beacon's location by human personnel and/or aid in uncovering the beacon itself. Although not required or limiting, step 274 can involve moving dirt, water, snow, or debris with one or more articulating tools. It is contemplated that a laser, heat, optics, and other tools can engage and alter the terrain in step 274 to aid in the discovery and recovery of a beacon. While physical tasks by a search device can help recover a beacon, such activity is not required, as illustrated by step 276 logging search device activity to allow a learning circuit to intelligently apply machine learning to improve future detection strategies, which corresponds with faster and more accurate beacon location and recoveries in the future.

Through the assorted embodiments of a beacon discovery system, a manually and/or autonomously controlled search device can be used for locating and identifying a beacon's signal. An aerial search drone may be a manual or autonomous device for search and rescue operations, such as in avalanche victim recovery and beacon locating. A search device can feature multiple pre-programmed modes that allows a user to quickly and efficiently locate one, or multiple, beacons in an emergency situation.

In some embodiments, a search device can be controlled manually and autonomously to perform an aerial search for a radio signal in designated areas. A search device can “lock” on autonomously to a radio signal and proceed to locate and designate target by multiple means, such as laser light, marker, and sound. Once a search drone has picked up a radio device signal, it will have the ability to automatically “lock” the signal and proceed to the located radio device signal and continue with its designation parameters, such as fly lower to set height and laser designated target.

A search device will be able to search autonomously for a radio signal with a variety of multiple search pattern functions. Other embodiments of a search device can have GPS location and radio detection capabilities as well as capabilities of detecting and marking multiple radio signals. As a result, a search device can be set to identify multiple radio signatures and locate specific radio signatures.

What is claimed is:

1. A system comprising:
a beacon comprising a first communication circuit; and
a first automated device comprising a detection module and a second communication circuit to pass signals to the first communication circuit, the automated device configured to discover the beacon by executing a detection strategy generated by the detection module.

2. The system of claim 1, wherein the beacon is physically positioned in an out-of-site location via the execution of a detection strategy by a detection module of the first automated device.

3. The system of claim 1, wherein the beacon comprises an alert circuit to control one or more identifying mechanisms to aid in the location of the beacon.

4. The system of claim 3, wherein the beacon comprises a trigger circuit to activate the alert circuit in response to the beacon is being discovered by the first automated device.

5. The system of claim 1, wherein the first automated device is an autonomous unmanned aerial drone.

6. The system of claim 1, wherein a second automated device is an autonomous unmanned ground vehicle configured to launch the first automated device in response to a threshold condition being detected, the threshold condition predicted by the detection strategy.

7. A method comprising:
launching an automated device comprising a detection module and a first communication circuit;
generating a detection strategy with the detection module in response to at least one detected condition; and
executing the detection strategy with the automated device to discover a beacon comprising a second communication circuit.

8. The method of claim 7, wherein the detection strategy prescribes a plurality of actions for the automated device to discover the beacon.

9. The method of claim 8, wherein the detection strategy alters from a first action of the plurality of actions to different a second action of the plurality of actions in response to a condition detected by a sensor of the automated device.

10. The method of claim 9, wherein the detected condition is a terrain mapped by the automated device.

11. The method of claim 9, wherein the detected condition is a weather parameter.

12. The method of claim 9, wherein the detected condition is a location of the beacon.

13. The method of claim 7, wherein detection module alters the detection strategy in response to the at least one detected condition to discover the beacon in a fastest possible location of a beacon.

14. The method of claim 7, wherein the detection strategy prescribes altering signal strength of the beacon in response to the automated device discovering a location of the beacon.

15. The method of claim 7, wherein the detection strategy prescribes a plurality of different automated device movement patterns to discover the beacon.

16. The method of claim 7, wherein the detection module comprises a learning module to generate a unique searching algorithm in response to the at least one detected condition.

17. The method of claim 16, wherein the detection strategy prescribes a plurality of different automated device elevations relative to a ground level to discover the beacon.

18. The method of claim 17, wherein the detection module predicts an efficiency of different elevations to discover the beacon based on the unique searching algorithm.

19. The method of claim 7, wherein the automated device predicts a depth of the beacon under ground in response to the passing of signals between the first and second communication circuits.

20. The method of claim 7, wherein the detection strategy prescribes engaging a ground surface with one or more tools in response to discovering a location of the beacon.
